(19) United States
(12) Patent Application Publication
(10) Pub. No.: US 2025/0244863 A1
(43) Pub. Date: Jul. 31, 2025

(54) SYSTEMS AND METHODS FOR USER-DEFINED SYNTHETIC DATA GENERATION VIA AN INTERACTIVE USER INTERFACE

(71) Applicant: Wells Fargo Bank, N.A., San Francisco, CA (US)

(72) Inventors: Carrie Anne Hanson, Charlotte, NC (US); Himanshu Baral, Fremont, CA (US); Ananth Kendapadi, Charlotte, NC (US); Rameshchandra Bhaskar Ketharaju, Hyderabad (IN); Manpreet Singh, Telangana (IN); Vinothkumar Venkataraman, Bangalore (IN); Ashutosh Verma, Karnataka (IN); Yang Angelina Yang, Mountain View, CA (US); Naveen Gururaja Yeri, Karnataka (IN)

(21) Appl. No.: 17/932,637

(22) Filed: Sep. 15, 2022

(51) Int. Cl. G06F 3/04847

(52) U.S. Cl. CPC G06F 3/04847

(57) ABSTRACT

Systems, apparatuses, methods, and computer program products are disclosed for user-defined synthetic data generation. A method includes generating, by interface generation circuitry, a synthetic data generation user interface (UI) comprising a plurality of synthetic data generation UI elements. The method also includes causing presentation, by communications hardware, of the synthetic data generation UI. The method also includes receiving, by the communications hardware, a user input set comprising a plurality of user input indications generated based on user interactions with the synthetic data generation UI elements. The method also includes preprocessing, by synthetic data generation circuitry, the user input set to generate a parameter specification set for generating a synthetic dataset.

### BACKGROUND

Synthetic data is valuable as a source of data for training models (e.g., machine learning models and the like). However, existing processes for generating synthetic data are often complex and require extensive domain knowledge, thus excluding certain end users.

### BRIEF SUMMARY

Synthetic data is emerging as an effective tool in the field of data science. Unlike authentic data (e.g., data generated based on real-world events), synthetic data is not obtained by direct measurement and is instead artificially manufactured. Synthetic data may be generated algorithmically and can be used as a stand-in for datasets of production and/or operational data. Synthetic data helps reduce constraints when faced with issues concerning sensitive or regulated data, and can also be used to tailor datasets to certain conditions that cannot be obtained from authentic data. Synthetic data that mimics real-world observations can also be used to train models (e.g., machine learning models) when authentic data is difficult and/or expensive to acquire.

However, as noted herein, effective creation of synthetic data has traditionally required end users to have extensive domain knowledge regarding how synthetic data is generated and various requirements for the synthetic data. In this regard, many individuals who may wish to generate and use synthetic data are not equipped with the sufficient training or experience to generate suitable synthetic data. In various situations, this can result in multiple technical problems. For instance, synthetic data sets may be generated that are unknowingly misrepresentative (or non-representative) of the authentic data sets that they are intended to replicate (e.g., stand-in for). If used to train a model (e.g., machine learning model), this misrepresentative synthetic data may cause various undesirable results, e.g., inaccurate model output, uninterpretable model output, model biases, etc. As another example, an individual that does not have access to quality synthetic data may instead rely solely on an inadequate authentic data set (e.g., inadequate in quantity and/or quality). If inadequate training data is used to train a model (e.g., a machine learning model), many of the undesirable results discussed above may also occur. To name just a few—inaccurate model output, uninterpretable model output, model biases, etc.

A technical need therefore exists for new tools that can facilitate the generation of synthetic data by a wider population while mitigating various undesirable results. Systems, apparatuses, methods, and computer program products are disclosed herein for user-defined synthetic data generation. Example embodiments leverage a user-friendly interactive interface that allows end users to define various requirements for a synthetic dataset. Through the interactive interface, a “low-code” solution to existing complex synthetic data generation processes is provided that makes efficient and suitable synthetic data generation available to, and accessible by, a wider population. Advantageously, the interactive user interface also provides insights into backend synthetic data generation processes traditionally unavailable for analysis by end users. In addition to the technical benefits described above, and elsewhere herein, the described systems, apparatuses, methods, and computer program products may result in improved machine learning model performance by virtue of error reduction in synthetic data sets used as machine learning model training data. That is, various examples described herein provide a technical advancement in the areas of machine learning model training and/or operation.

In one example embodiment, a method is provided for user-defined synthetic data generation. The method includes generating, by interface generation circuitry, a synthetic data generation user interface (UI) comprising a plurality of synthetic data generation UI elements. The method also includes causing presentation, by communications hardware, of the synthetic data generation UI. The method also includes receiving, by the communications hardware, a user input set comprising a plurality of user input indications generated based on user interactions with the synthetic data generation UI elements. The method also includes preprocessing, by synthetic data generation circuitry, the user input set to generate a parameter specification set for generating a synthetic dataset.

In another example embodiment, an apparatus is provided for user-defined synthetic data generation. The apparatus includes interface generation circuitry configured to generate a synthetic data generation user interface (UI) comprising a plurality of synthetic data generation UI elements. The apparatus also includes communications hardware configured to cause presentation of the synthetic data generation UI. The communications hardware is also configured to receive a user input set comprising a plurality of user input indications generated based on user interactions with the synthetic data generation UI elements. The apparatus also includes synthetic data generation circuitry configured to preprocess the user input set to generate a parameter specification set for generating a synthetic dataset.

In another example embodiment, a computer program product is provided for user-defined synthetic data generation. The computer program product includes at least one non-transitory computer-readable storage medium storing software instructions that, when executed, cause an apparatus to generate a synthetic data generation user interface (UI) comprising a plurality of synthetic data generation UI elements. The software instructions, when executed, also cause the apparatus to cause presentation of the synthetic data generation UI. The software instructions, when executed, also cause the apparatus to receive a user input set comprising a plurality of user input indications generated based on user interactions with the synthetic data generation UI elements. The software instructions, when executed, also cause the apparatus to preprocess the user input set to generate a parameter specification set for generating a synthetic dataset.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for user-defined synthetic data generation.

FIG. 2 illustrates a schematic block diagram of example circuitry embodying a device that may perform various operations in accordance with some example embodiments described herein.

FIG. 3 illustrates an example flowchart for user-defined synthetic data generation, in accordance with some example embodiments described herein.

FIG. 4 illustrates an example flowchart for generating and communicating a time-to-generate estimation for a synthetic dataset, in accordance with some example embodiments described herein.

FIG. 5 illustrates an example flowchart for user-defined synthetic data generation, in accordance with some example embodiments described herein.

FIG. 6A illustrates an example user interface used in some example embodiments described herein.

FIG. 6B illustrates an example user interface used in some example embodiments described herein.

FIG. 6C illustrates an example user interface used in some example embodiments described herein.

FIG. 6D illustrates an example user interface used in some example embodiments described herein.

FIG. 6E illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

### Overview

As noted above, methods, apparatuses, systems, and computer program products are described herein that provide for user-defined synthetic data generation. Traditionally, synthetic data generation has been a complex process that requires extensive knowledge of certain data, modeling techniques, and/or highly technical data requirements. These traditional processes force teams of individuals to articulate various needs for synthetic data clearly. However, without a centralized and/or visual means of communication, information may become lost or unclear, resulting in the generation of unsuitable synthetic data. Further, as mentioned herein, these conventional processes for generating synthetic data are often complex and require extensive knowledge, leaving less advanced users who may need to generate synthetic data unable to effectively do so.

Example embodiments herein provide a technical solution to the issues described above in the form of a platform (e.g., a Software-as-a-Service (SaaS) platform) that provides a user interface (UI) with which users can easily interact to define necessary elements of a synthetic data set and that will subsequently automatically generate a suitable synthetic data set. The synthetic data generation UI enables users to easily modify various information of the synthetic data using intuitive UI design elements. The information that can be modifiable may include metadata about the data to be synthetically created (e.g., types of data, location of data, amount of data), privacy levels and/or requirements (e.g., a level of obfuscation from source data), allowable degree of bias (e.g., enabling intentionally biased data or a more normal distribution), allowable degree of recycling of authentic data, or any other suitable parameter.

The UI may enable selection of algorithms to use for synthetic data generation (e.g., Monte-Carlo methods, neural networks, other ML-based methods, etc.). In addition, the synthetic data generation system may enable testing of the synthetic data (e.g., via model building and testing). In some embodiments, the system may enable real-time generation and delivery of synthetic data without intermediate storage of the synthetic data, thereby permitting generation of synthetic data from sensitive source data without compromising security of the sensitive source data.

The system may enable time-to-generate tradeoffs (and may visualize time-to-generate estimates for the user based on the user selections). In addition, the system may store previously generated synthetic data sets (e.g., “vanilla” data sets) that can be used as source data from which user-specific synthetic data is generated. Finally, the system may be hosted by a large entity (e.g., an organization, corporation, or the like) that has significant volumes of real information, thereby offering a data advantage to users of the system over synthetic data provided from other sources.

Although a high-level explanation of the operations of example embodiments has been provided above, specific details regarding the configuration of such example embodiments are provided below.

### System Architecture

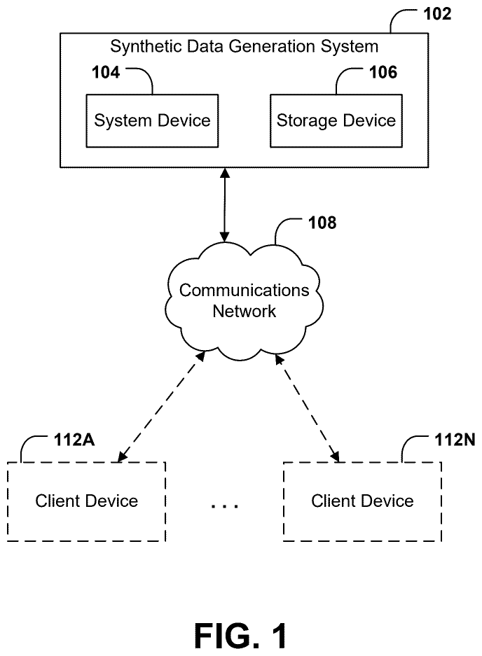

Example embodiments described herein may be implemented using any of a variety of computing devices and/or servers. To this end, FIG. 1 illustrates an example environment within which various embodiments may operate. As illustrated, a synthetic data generation system 102 may include a system device 104 in communication with a storage device 106. Although system device 104 and storage device 106 are described in singular form, some embodiments may utilize more than one system device 104 and/or more than one storage device 106. Additionally, some embodiments of the synthetic data generation system 102 may not require a storage device 106 at all. Whatever the implementation, the synthetic data generation system 102, and its constituent system device(s) 104 and/or storage device(s) 106 may receive and/or transmit information via communications network 108 (e.g., the Internet) with any number of other devices, such as one or more of client device 112A through client device 112N.

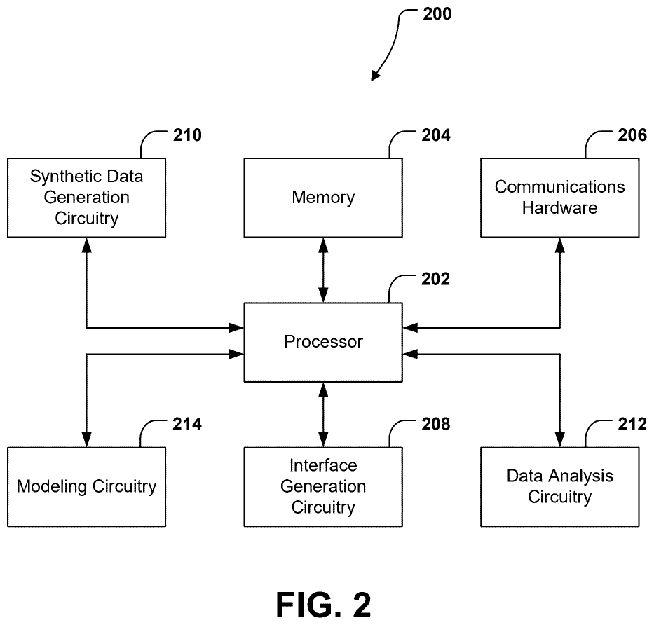

System device 104 may be implemented as one or more servers, which may or may not be physically proximate to other components of synthetic data generation system 102. Furthermore, some components of system device 104 may be physically proximate to the other components of synthetic data generation system 102 while other components are not. System device 104 may receive, process, generate, and transmit data, signals, and electronic information to facilitate the operations of the synthetic data generation system 102. Particular components of system device 104 are described in greater detail below with reference to apparatus 200 in connection with FIG. 2.

Storage device 106 may comprise a distinct component from system device 104 or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the synthetic data generation system 102. Storage device 106 may store information relied upon during operation of the synthetic data generation system 102, such as various datasets such as authentic datasets, previously generated synthetic datasets, and/or the like that may be used by the synthetic data generation system 102. In addition, storage device 106 may store control signals, device characteristics, and access credentials enabling interaction between the synthetic data generation system 102 and one or more of the client devices 112A-112N.

The one or more client devices 112A-112N may be embodied by any computing devices known in the art, such as desktop or laptop computers, tablet devices, smartphones, or the like. The one or more client devices 112A-112N need not themselves be independent devices but may be peripheral devices communicatively coupled to other computing devices.

Although FIG. 1 illustrates an environment and implementation in which the synthetic data generation system 102 interacts with one or more of client devices 112A-112N, in some embodiments users may directly interact with the synthetic data generation system 102 (e.g., via communications hardware of system device 104). Whether by way of direct interaction or via a separate client device 112A-112N, a user may communicate with, operate, control, modify, or otherwise interact with the synthetic data generation system 102 to perform the various functions and achieve the various benefits described herein.

### Example Implementing Apparatuses

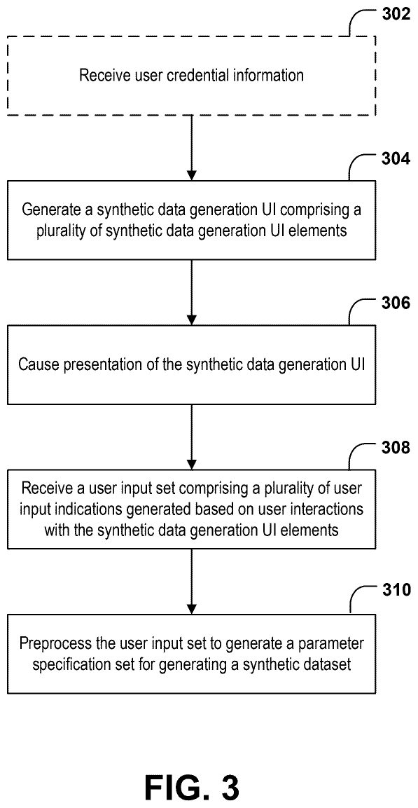

System device 104 of the synthetic data generation system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, interface generation circuitry 208, synthetic data generation circuitry 210, data analysis circuitry 212, and modeling circuitry 214, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described above in connection with FIG. 1 and below in connection with FIGS. 3-5.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may also be configured to provide output to a user and, in some embodiments, to receive an indication of user input. The communications hardware 206 may comprise an interface, such as a display, and may further comprise the components that govern use of the interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these interface elements through software instructions (e.g., application software and/or system software, such as firmware) stored on a memory (e.g., memory 204) accessible to the processor 202.

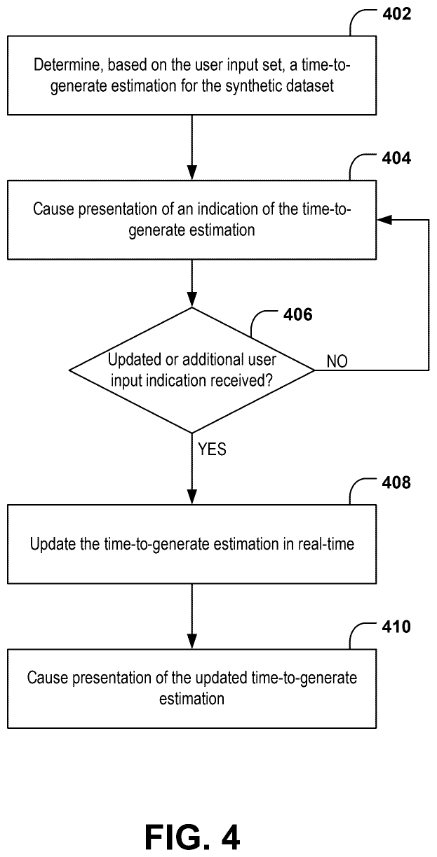

In addition, the apparatus 200 further comprises interface generation circuitry 208 that generates a synthetic data generation user interface. The interface generation circuitry 208 may utilize processor 202, memory 204, or any other hardware component included in the apparatus 200 to perform these operations, as described in connection with at least FIGS. 3-5 below. The interface generation circuitry 208 may further utilize communications hardware 206 to gather data from a variety of sources (e.g., client devices 112A-112N and/or storage device 106, as shown in FIG. 1) and/or to receive data from a user, and in some embodiments may utilize processor 202 and/or memory 204 to configure and generate a synthetic data generation user interface (e.g., based on a user credential information, as further described herein in connection with at least FIG. 4).

In addition, the apparatus 200 further comprises synthetic data generation circuitry 210 that preprocesses a user input set to generate a parameter specification set, and generates a synthetic dataset based on the parameter specification set. The synthetic data generation circuitry 210 may utilize processor 202, memory 204, or any other hardware component included in the apparatus 200 to perform these operations, as described in connection with at least FIGS. 3-5 below. The synthetic data generation circuitry 210 may further utilize communications hardware 206 to gather data from a variety of sources (e.g., client devices 112A-112N and/or storage device 106, as shown in FIG. 1) and/or to receive data from a user, and in some embodiments may utilize processor 202 and/or memory 204 to generate a synthetic dataset.

In addition, the apparatus 200 further comprises data analysis circuitry 212 that determines a data time-to-generate estimation for a synthetic dataset. The data analysis circuitry 212 may utilize processor 202, memory 204, or any other hardware component included in the apparatus 200 to perform these operations, as described in connection with at least FIGS. 3-5 below. The data analysis circuitry 212 may further utilize communications hardware 206 to gather data from a variety of sources (e.g., client devices 112A-112N and/or storage device 106, as shown in FIG. 1) and/or to receive data from a user, and in some embodiments may utilize processor 202 and/or memory 204 to determine a time-to-generate estimation for a synthetic dataset and update the time-to-generate estimation in response to receiving an updated or additional user input indication.

In addition, the apparatus 200 further comprises modeling circuitry 214 that trains a model using a synthetic dataset and, in some embodiments, tests and generates output data of the trained model. For example, output data may comprise one or more predicted outputs based on corresponding inputs to the model. The modeling circuitry 214 may utilize processor 202, memory 204, or any other hardware component included in the apparatus 200 to perform these operations, as described in connection with at least FIGS. 3-5 below. In some embodiments, the modeling circuitry 214 may comprise a model (or multiple models), such as a machine learning (ML) model (e.g., supervised or unsupervised), artificial intelligence (AI) reasoning model, and/or the like which is utilized to generate output data (e.g., predicted outputs) based on corresponding input data provided to the model. In some embodiments, an example model of the modeling circuitry 214 may be trained using a synthetic dataset generated by the synthetic data generation system 102. The example model may be trained exclusively using synthetic data, or, in other embodiments, the model may be partially trained using synthetic data (while also using authentic data as training data).

Although components 202-214 are described in part using functional language, it will be understood that the particular implementations necessarily include the use of particular hardware. It should also be understood that certain of these components 202-214 may include similar or common hardware. For example, the interface generation circuitry 208, synthetic data generation circuitry 210, data analysis circuitry 212, and modeling circuitry 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the interface generation circuitry 208, synthetic data generation circuitry 210, data analysis circuitry 212, and modeling circuitry 214 may leverage processor 202, memory 204, or communications hardware 206 as described above, it will be understood that any of these elements of apparatus 200 may include one or more dedicated processors, specially configured field programmable gate arrays (FPGA), neural engine(s), neural compute stick(s), tensor processing units (TPU), graphical processing unit (GPU), and/or application specific interface circuits (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the interface generation circuitry 208, synthetic data generation circuitry 210, data analysis circuitry 212, and modeling circuitry 214 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the apparatus 200. Thus, some or all of the functionality described herein may be provided by third-party circuitry. For example, apparatus 200 may access one or more third-party circuitries via any sort of networked connection that facilitates transmission of data and electronic information between the apparatus 200 and the third-party circuitries. In turn, apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

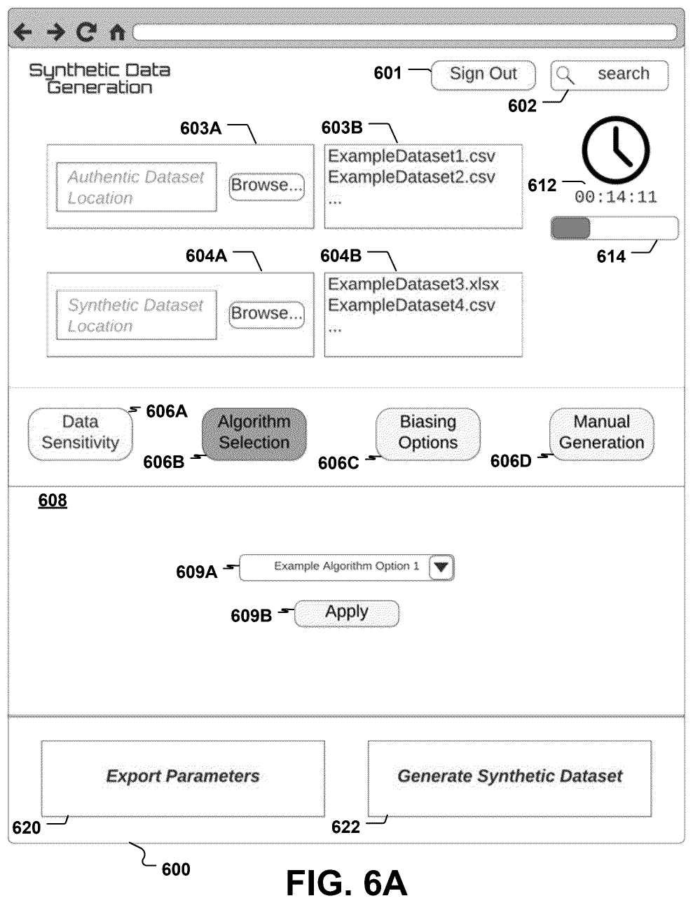

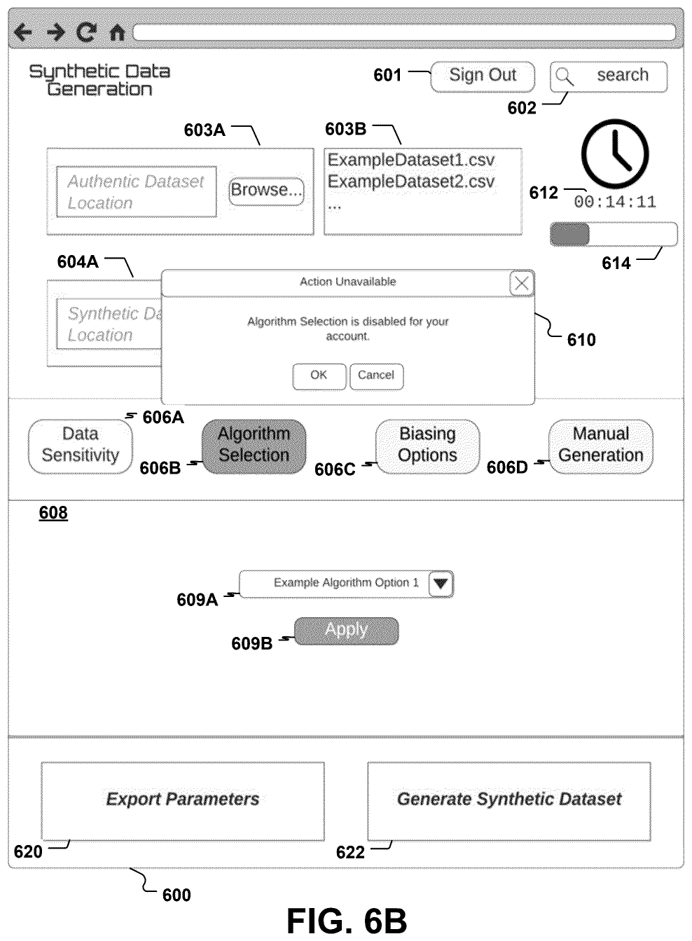

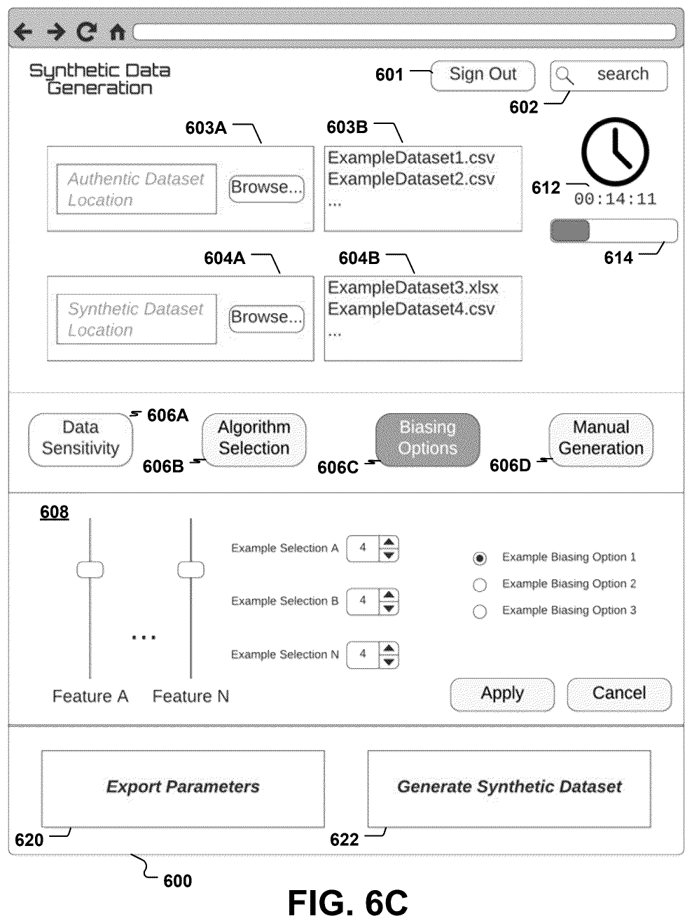

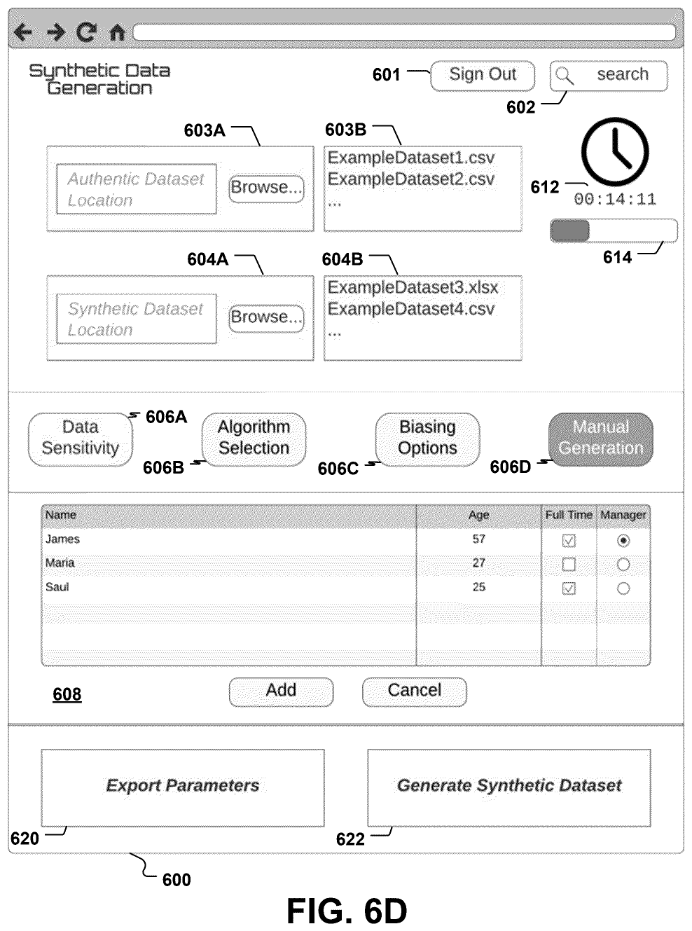

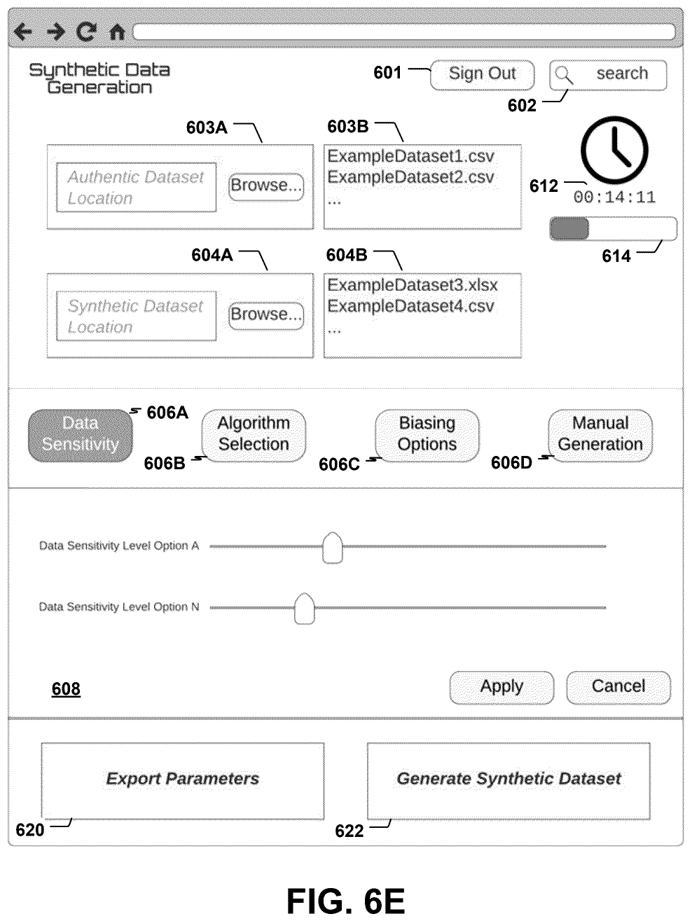

Turning to FIGS. 3-5, example flowcharts are illustrated that contain example operations implemented by example embodiments described herein. Certain operations of FIGS. 3-5 may be described in connection with description of example synthetic data generation user interfaces shown in FIGS. 6A-6E. The operations illustrated in FIGS. 3-5 may, for example, be performed by system device 104 of the synthetic data generation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, interface generation circuitry 208, synthetic data generation circuitry 210, data analysis circuitry 212, modeling circuitry 214 and/or any combination thereof. It will be understood that user interaction with the synthetic data generation system 102 may occur directly via communications hardware 206, or may instead be facilitated by separate client device(s) 112A-112N, as shown in FIG. 1, and which may have similar or equivalent physical componentry facilitating such user interaction.

Turning first to FIG. 3, example operations are shown for user-defined synthetic data generation.

As shown by operation 302, the apparatus 200 may include means, such as processor 202, memory 204, communications hardware 206, and/or the like, for receiving user credential information. User credential information may comprise any type of data used to identify a user. For example, in some embodiments, user credential information may comprise a username and/or password. In some embodiments, user credential information may comprise a biometric identifier (or a combination of biometric identifiers) of a user, such as a retinal scan, fingerprint, voice capture, and/or the like.

Regardless of the type of user credential information, the user credential information may be received in response to an attempt by a user to log in to the synthetic data generation system 102. As noted above, in some embodiments, a user may interact directly with the synthetic data generation system 102, such that the user credential input is received via direct input to the synthetic data generation system 102. In other embodiments, a user may interact indirectly with the synthetic data generation system 102, such as remotely via a client device (e.g., client device 112A). In this regard, the user credential information may be received via communications network 108.

In some embodiments, the received user credential information may be analyzed to identify the user that is attempting to log in to the synthetic data generation system 102. For example, the user credential information may be compared with stored user credential information of registered users to determine whether the user credential information matches that of a registered user. In some embodiments, an entity such as an organization, corporation, or the like may manage the synthetic data generation system 102 as well as a plurality of registered users of the synthetic data generation system 102. For example, registered users of the synthetic data generation system 102 may comprise employees of the entity. In some embodiments, different levels of access to various features of the synthetic data generation system 102 may be predefined for registered users of the synthetic data generation system 102. In this regard, more advanced users (e.g., data scientists or the like) may have access to certain features of the synthetic data generation system 102 that other, less advanced users do not. However, it is to be appreciated that in some embodiments, user login to the synthetic data generation system 102 may not be required at all and all features of the synthetic data generation system 102 may be available to any user.

As shown by operation 304, the apparatus 200 includes means, such as processor 202, memory 204, interface generation circuitry 208, and/or the like, for generating a synthetic data generation user interface (UI) comprising a plurality of synthetic data generation UI elements. As shown by operation 306, the apparatus 200 includes means, such as processor 202, memory 204, interface generation circuitry 208, and/or the like, for causing presentation of the synthetic data generation UI. In some embodiments, the synthetic data generation UI may be generated and displayed in response to the received user credential information matching that of a registered user. In other words, once the user is authorized in that the user is determined to be a registered user of the synthetic data generation system 102, the synthetic data generation UI may be generated and displayed.

Turning briefly to FIG. 6A, and with continuing reference to at least FIG. 3, an example synthetic data generation UI 600 is shown. In some embodiments, synthetic data generation UI 600 may be displayed and accessed by a user via a web browser (as depicted in FIG. 6A). In some embodiments, the synthetic data generation UI 600 may be displayed and accessed by a user via a standalone application (e.g., a desktop app, a mobile app, or the like). As shown in FIG. 6A (as well as in FIGS. 6B-6E), the synthetic data generation UI 600 may comprise a plurality of synthetic data generation UI elements (further described below) that may include various buttons, fillable fields, selectable icons, indicators, sliders, and/or other types of user interface elements. The synthetic data generation UI elements may be interacted with by a user via communications hardware 206 (e.g., a keyboard, mouse, etc.). In some embodiments, the synthetic data generation UI elements may be interacted with by a user via a touch display (e.g., at a client device 112A, such as a mobile phone, tablet, or the like).

Through user interaction with the various synthetic data generation UI elements of the synthetic data generation UI 600, user input indications may be received by the synthetic data generation system 102. Returning briefly to FIG. 3, as shown by operation 308, the apparatus 200 includes means, such as processor 202, memory 204, communications hardware 206, and/or the like, for receiving a user input set comprising a plurality of user input indications generated based on user interactions with the synthetic data generation UI elements. For example, a user input indication may indicate a selection of one of several options for a particular element, an uploaded file or a pointer to an uploaded file, manual text input, and/or the like, as further described herein.

Returning to FIG. 6A, the example synthetic data generation UI 600 may include a sign out button 601 enabling the user to sign out of their registered user account. The example synthetic data generation UI 600 may also include a search field 602 that enables a user to search for various tools or features within the synthetic data generation UI 600.

The example synthetic data generation UI 600 may include an authentic dataset upload element 603A. By selecting the “browse” button within the authentic dataset upload element 603A, a user may upload or provide a pointer to an authentic dataset (e.g., a dataset made up of real data points) to be used in the generation of a synthetic dataset. In this regard, in some embodiments, the synthetic data generation system 102 may generate a synthetic dataset using an uploaded authentic dataset as a source dataset, or in other words, generate a synthetic dataset that mimics the authentic dataset and/or includes portions of the authentic dataset. The synthetic data generation UI 600 may include an authentic dataset upload indication element 603B that lists filenames of authentic datasets as the datasets are input by the user. As shown, an example user has input two authentic datasets, “ExampleDataset1.csv” and “ExampleDataset2.csv.” Though FIG. 6A depicts uploaded datasets as .CSV and .XLSX files types, it is to be appreciated that other file types may be recognized and/or processed by the synthetic data generation system 102. In some embodiments, the authentic dataset may not be uploaded to the synthetic data generation system 102. For example, the authentic dataset may be stored on a client device 112A of the user that is interacting with the synthetic data generation system 102 using the client device 112A. The authentic dataset may contain sensitive data points that the user may not be willing to upload to the synthetic data generation system 102 avoid the risk of exposure during transmission. In this regard, any dataset input into the authentic dataset upload element 603A may not be uploaded to the synthetic data generation system 102 until the generate synthetic dataset button 622 is selected (as described further below).

The example synthetic data generation UI 600 may include a synthetic dataset upload element 604A, both to expedite the process of generating new synthetic data and to offer the ability to harmonize the characteristics of new synthetic data with the characteristics of existing synthetic data (e.g., where expansion of an existing synthetic dataset is desired). By selecting the “browse” button within the synthetic dataset upload element 604A, a user may upload a previously generated synthetic dataset to be used in the generation of a new synthetic dataset. In this regard, the synthetic data generation system 102 may generate a synthetic dataset using a previously generated synthetic dataset as a source dataset, or in other words, generate a synthetic dataset that mimics the previously generated synthetic dataset and/or includes portions of the previously generated synthetic dataset (e.g., a partially synthetic dataset). The synthetic data generation UI 600 may include a synthetic dataset upload indication element 604B that lists filenames of synthetic datasets as the datasets are uploaded by the user. As shown, an example user has uploaded two synthetic datasets, “ExampleDataset3.xlsx” and “ExampleDataset4.csv.” Though not shown in FIG. 6A, the synthetic data generation UI 600 may enable the user (e.g., upon selecting the “browse” button within the synthetic dataset upload element 604A) to review historical or previously generated synthetic datasets that have been generated by the synthetic data generation system 102. For example, the previously generated synthetic datasets that have been generated by the user (and/or other users) may be stored by the synthetic data generation system 102. In some embodiments, the synthetic data generation UI 600 may provide the ability for a user to not allow a synthetic dataset to be accessible by other users (e.g., in cases in which the synthetic dataset mimics extremely sensitive authentic data or other similar situations).

The example synthetic data generation UI 600 may include a pane comprising a plurality of selectable buttons 606A through 606D that cause corresponding changes to the elements displayed in pane 608 that, in turn, enable a user to further define various features, metadata, parameters, and/or the like of a desired synthetic dataset. Although four selectable buttons 606A-606D are shown, it is to be appreciated that the synthetic data generation UI 600 may include additional (or fewer) selectable buttons. In this example of the synthetic data generation UI 600 shown in FIG. 6A, a user has selected the algorithm selection button 606B, as evidenced by the darker shade of the algorithm selection button 606B compared with the other buttons 606A, 606C, and 606D.

Any specific implementation of the synthetic data generation UI 600 will leverage a series of predefined associations between sets of synthetic data generation UI elements and corresponding selectable buttons 606A-606D (and/or other selectable buttons). Accordingly, upon selection of one of the selectable buttons 606A-606D, one or more synthetic data generation UI elements associated with the selected button may be displayed in pane 608. For instance, FIG. 6A shows an example implementation in which selection of the algorithm selection button 606B causes an algorithm selection menu 609A to be displayed in pane 608.

In embodiments using this particular set of synthetic data generation UI elements, a user may select an algorithm of their choice to be used to generate a synthetic dataset by the synthetic data generation system 102. In this regard, the user input set received by the synthetic data generation system 102 may comprise a selection of one or more predefined synthetic data generation algorithms. For instance, a user may select one or more predefined synthetic data generation algorithms via the algorithm selection menu 609A and select the apply button 609B to generate a user input indication indicating the selection of one or more predefined algorithms.

As noted above, in some embodiments, the synthetic data generation UI 600 may be generated based on received user credential information. In this regard, the user may be identified as a specific type of user (e.g., a normal user, an advanced user, etc.) such that the synthetic data generation system 102 may generate the synthetic data generation UI 600 to be tailored to the specific type of user. For instance, in some embodiments, depending on the type of user, certain synthetic data generation UI elements of the synthetic data generation UI 600 may be unavailable to interact with by the user. In this regard, the apparatus 200 includes means, such as processor 202, memory 204 interface generation circuitry 208, or the like, for disabling one or more synthetic data generation UI elements based on the user credential information.

As one example, algorithm selection may only be available to more advanced (e.g., more knowledgeable, or more experienced) users (e.g., data scientists and/or others who have a better understanding of the various predefined algorithms). In this regard, less advanced users may be unable to select algorithms from the algorithm selection menu 609A and instead, a default algorithm choice may be applied by the synthetic data generation system 102. In this regard, the apparatus 200 includes means, such as processor 202, memory 204, interface generation circuitry 208, or the like, for automatically applying default settings to one or more synthetic data generation UI elements based on the user credential information. An example is shown in FIG. 6B, wherein an alert message 610 is displayed upon a user selecting the algorithm selection button 606B. The alert message may indicate that the particular feature (in this case, algorithm selection) is disabled for the user's account. Additionally, the apply button 609B may be grayed out and deactivated such that the user is unable to select the apply button. A default setting (e.g., “Example Algorithm Option 1”) is also automatically applied to the algorithm selection menu 609A.

As shown in FIG. 6C, upon selection of the biasing options button 606C, a plurality of synthetic data generation UI elements related to biasing options and other options may be displayed in pane 608. The synthetic data generation UI elements that are displayed in pane 608 may include various sliders, menus, radio buttons, and/or other elements that enable a user to define various properties of a synthetic dataset prior to generation of the synthetic dataset.

In some embodiments, a user may select a degree of bias that may affect a statistical distribution of data points in a generated synthetic dataset. In this regard, the user input set may comprise an indication of a selected degree of bias. As a simple example, for an example synthetic dataset related to a human population, a degree of bias may be selected such that the synthetic dataset may have more data points regarding females than data points regarding males. Upon generating the synthetic dataset (as described further below), data points may be generated for the synthetic dataset according to the selected degree of bias (e.g., additional female data points may be generated). In this regard, the apparatus 200 includes means, such as processor 202, memory 204, synthetic data generation circuitry 210, or the like, for generating, by the synthetic data generation circuitry, a plurality of data points of the synthetic dataset based on the selected degree of bias.

The synthetic data generation UI elements that are displayed in pane 608 as shown in FIG. 6C may also include other various options for defining various properties of a generated synthetic dataset. For example, types of statistical distributions to base the synthetic dataset on, degree of class separation, number of features, length of the dataset, and/or the like may all be selected via the synthetic data generation UI elements displayed in pane 608.

As shown in FIG. 6D, upon selection of the manual generation button 606D, one or more synthetic data generation UI elements related to manual user generation of synthetic data points may be displayed in pane 608. Rather than using one or more algorithms to automatically generate values for the various fields associated with synthetic data points, the synthetic data generation UI 600 may enable a user to manually enter values for the fields associated with one or more synthetic data points to be included in the synthetic dataset. In this regard, an interactive table may be displayed that allows a user to create and further define various data points and features of said data points to be included in a generated synthetic dataset. For instance, as shown in FIG. 6D, pane 608 enables manual population of data points that describe various employees at an organization (in this case, with predefined fields for name, age, work status, and managerial status). While not shown in FIG. 6D, selection of the manual generation button 606D may cause pane 608 to display other user-selectable elements allowing a user to define the various fields that can be populated for a new synthetic data set (e.g., in the employee example shown in FIG. 6D, other fields regarding each employee, such as salary, location, or the like, may be added and populated via user interaction with pane 608).

As shown in FIG. 6E, upon selection of the data sensitivity button 606A, one or more synthetic data generation UI elements related to a data sensitivity level of a generated synthetic dataset may be displayed in pane 608. Through interacting with the synthetic data generation UI elements shown in pane 608 of FIG. 6E, a user may define a data sensitivity level (or multiple data sensitivity levels) for a synthetic dataset. In this regard, when dealing with sensitive authentic data that requires a high level of privacy (e.g., an authentic dataset uploaded via 603A), a user may set a higher data sensitivity level for the generated synthetic dataset. A higher data sensitivity level results in data points of a generated synthetic dataset being obfuscated from the source authentic data to a greater degree (e.g., no synthetic data points in a generated synthetic dataset will directly match any authentic data points in an uploaded authentic dataset). A lower data sensitivity level may result in some synthetic data points matching some authentic data points in the uploaded authentic dataset. In this regard, the user input set may comprise a data sensitivity level indication based on the user's preference of data sensitivity.

As shown in FIGS. 6A-6E, the example synthetic data generation UI 600 may also include a time-to-generate estimation indicator 612. In this regard, in some embodiments, the synthetic data generation system 102 may determine an estimated time required to fully generate a synthetic dataset based on a received user input set that defines the requirements and various parameters for the synthetic dataset.

Turning briefly to FIG. 4, example operations for generating and communicating a time-to-generate estimation for a synthetic dataset are shown. As shown by operation 402, the apparatus 200 includes means, such as processor 202, memory 204, data analysis circuitry 212, or the like, for determining, based on the user input set, a time-to-generate estimation for the synthetic dataset. In this regard, more complex user input sets (e.g., having multiple uploaded authentic and/or synthetic source datasets, more complex options selected, greater data sensitivity settings, etc.) may result in a greater time-to-generate estimation than less complex user input sets.

As shown by operation 404, the apparatus 200 includes means, such as processor 202, memory 204, communications hardware, or the like, for causing presentation of an indication of the time-to-generate estimation. As shown in FIGS. 6A-6E, the time-to-generate estimation may be displayed as a time-to-generate estimation indicator 612, which may include a number of hours, minutes, and/or seconds estimated to be required to generate the synthetic dataset.

Advantageously, the time-to-generate estimation may be continuously determined and updated in real-time as a user interacts with the synthetic data generation UI 600. In this regard, as a user makes various selections via the synthetic data generation UI elements of the synthetic data generation UI 600, the time-to-generate estimation may be continuously re-assessed by the synthetic data generation system 102 to reflect a more accurate time estimation. By consistently displaying an up-to-date time-to-generate estimation in real-time, a user may be made aware not only of the time needed to generate a synthetic dataset, but also of how much computational power and/or resources are being utilized to generate the synthetic dataset. In this regard, a higher time-to-generate estimation may inform the user on their computational resource usage and cause the user to make decisions to reduce their computational resource usage through changing one or more settings via the synthetic data generation UI 600 or the like.

Returning to FIG. 4, as shown by decision point 406, in an instance in which an updated or additional user input indication has not been received by the synthetic data generation system 102, the method may return to operation 404 wherein the time-to-generate estimation may continue to be displayed via the synthetic data generation UI 600. In an instance in which an updated or additional user input indication is received by the synthetic data generation system 102, the method may continue to operation 408, wherein the apparatus includes means, such as processor 202, memory 204, data analysis circuitry 212, or the like, for updating the time-to-generate estimation in real-time. In this regard, the synthetic data generation system 102 may factor the updated or additional user input indication into a determination of the time-to-generate estimation to more accurately reflect a time required to generate the synthetic dataset. For instance, if the user has uploaded an additional authentic and/or synthetic dataset, the time-to-generate estimation may be increased based on the size of the uploaded dataset. As another example, if the user has selected a lower data sensitivity level, the time-to-generate estimation may be lowered (e.g., by having a lower data sensitivity level, less synthetic data points may need to be generated for a new synthetic dataset, and instead, some data points of an uploaded authentic dataset and/or previously generated dataset may be able to be reused for the new synthetic dataset).

As shown by operation 410, the apparatus 200 includes means, such as processor 202, memory 204, communications hardware 206, or the like, for causing presentation of the updated time-to-generate estimation. As mentioned above, an updated time-to-generate estimation may be generated in real-time, such that the updated time-to-generate estimation may be presented in real-time in response to user interactions with the synthetic data generation UI 600.

As shown in FIGS. 6A-6E, the example synthetic data generation UI 600 may also include an export parameters button 620 and a generate synthetic dataset button 622.

In response to a user selecting the export parameters button 620, the synthetic data generation system 102 may preprocess the user input set to generate a parameter specification set. In this regard, as shown in operation 310 of FIG. 3, the apparatus 200 includes means, such as processor 202, memory 204, synthetic data generation circuitry 210, or the like, for preprocessing the user input set to generate a parameter specification set for generating a synthetic dataset.

In some embodiments, preprocessing the user input set to generate a parameter specification set may include translating some or all of the user input set into instructions that, when executed, are configured to generate a synthetic dataset. In this regard, a generated parameter specification set may comprise an executable file capable of being exported to another device (e.g., such as a client device 112A) at which the file can be executed to generate a synthetic dataset via a processor and memory of the device. Advantageously, when the export parameters button 620 is selected, the synthetic data generation system 102 may enable real-time delivery of a synthetic dataset (e.g., in the form of an executable parameter specification set) without intermediate storage of the synthetic dataset, thereby permitting generation of synthetic data from sensitive source data (e.g., a sensitive authentic dataset) without compromising security of the sensitive source data. In this regard, the apparatus 200 includes means, such as processor 202, memory 204, communications hardware 206, or the like, for causing transmission of a parameter specification set. As mentioned above, in some embodiments, a sensitive authentic dataset may be stored locally at a client device 112A. Rather than uploading the sensitive authentic dataset to the synthetic data generation system 102, a user may elect to instead export the parameter specification set to their local device (e.g., via selecting the export parameters button 620) in order to generate the synthetic dataset directly on their device without having to move the sensitive authentic dataset to another system.

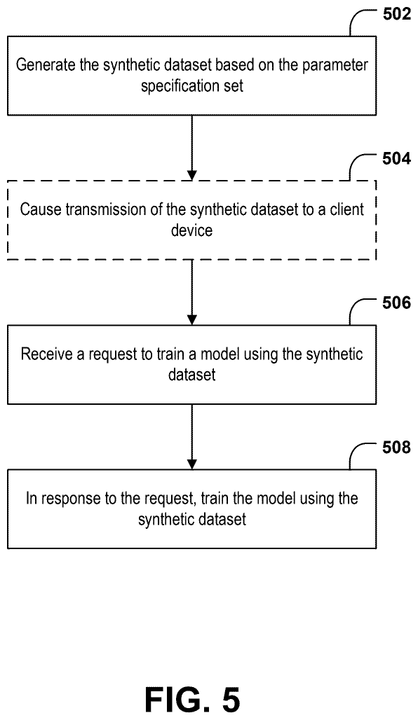

Turning to FIG. 5, as shown by operation 502, the apparatus 200 includes means, such as processor 202, memory 204, synthetic data generation circuitry 210, or the like, for generating the synthetic dataset based on the parameter specification set. In this regard, in response to a user selecting the generate synthetic dataset button 622, the synthetic data generation system 102 may again preprocess the user input set to generate a parameter specification set. However, instead of causing transmission of the parameter specification set to a client device, the synthetic data generation system 102 may itself generate (and at least temporarily store) the synthetic dataset. The selection of the generate synthetic dataset button 622 may cause any datasets input into the authentic dataset upload element 603A and/or synthetic dataset upload element 604A to be automatically uploaded to the synthetic data generation system 102 and processed to create the synthetic dataset.

In some embodiments, as shown in FIGS. 6A-6E, the synthetic data generation UI 600 may include a progress bar 614 that visualizes progress of the generation of a parameter specification set and/or synthetic dataset. This progress bar may visually indicate a fraction of the synthetic data generation steps that have been completed by the user (e.g., using a two-color graphic illustrating the completed fraction via expansion of one color across the progress bar, interpretable in the manner of a thermometer). In some embodiments, this visual indication may be accompanied by a completion percentage displayed above or below the progress bar. The progress bar may automatically update each time a user has entered data into a field or taken another action indicating completion of a field. The percentage of the progress bar in one of the colors may correspond to the percentage of the fields for which data is entered (or that are indicated as complete). In a more complex implementation, each field has a corresponding weight, such that completion of some field will cause larger changes in the progress bar than completion of other fields. In some embodiments, upon selection of the export parameters button 620, or the generate synthetic dataset button 622, the progress bar 614 may be displayed and updated in conjunction with the time-to-generate estimation indicator 612. Further, upon selection of the export parameters button 620, or the generate synthetic dataset button 622, the time-to-generate estimation may begin visually counting down (e.g., counting down to zero (0) in hours, minutes, seconds) until generation of the synthetic dataset (or parameter specification set) is completed.

As shown by operation 504, the apparatus 200 may include means, such as processor 202, memory 204, communications hardware 206, and/or the like, for causing transmission of the synthetic dataset to a client device. In this regard, the synthetic dataset, once generated, may be transmitted to a client device of a user for review and/or further processing. In some embodiments, rather than causing transmission of the synthetic dataset, the synthetic data generation system 102 may instead cause presentation of the synthetic dataset for user review. In this regard, the apparatus 200 includes means, such as processor 202, memory 204, communications hardware 206, and/or the like, for causing presentation of the synthetic dataset. For example, the synthetic dataset may be displayed (e.g., in a table format or the like) at a client device 112A or directly at the synthetic data generation system 102.

In some embodiments, upon user review and approval of the synthetic dataset, the user may request that a model be trained using the synthetic dataset. In this regard, as shown by operation 506, the apparatus 200 includes means, such as processor 202, memory 204, communications hardware 206, and/or the like, for receiving a request to train a model using the synthetic dataset. The request may be transmitted via user interaction with the synthetic data generation UI 600. As shown by operation 508, the apparatus 200 includes means, such as processor 202, memory 204, modeling circuitry 214, and/or the like, for training the model using the synthetic dataset. After the model has been trained, the model may be provided to the user for further processing. In this regard, the apparatus 200 may include means, such as processor 202, memory 204, communications hardware 206, or the like, for causing transmission of a trained model to a client device.

In some embodiments, training the model (as well as generating the synthetic dataset) may be performed in a high security environment in order to minimize exposure of any sensitive data related to an uploaded authentic dataset. The high security environment may include one or more computing devices which can temporarily store the model and/or uploaded datasets. The high security environment may include a physical zone only accessible to select trusted personnel. The high security environment may include various data protection mechanisms, such as firewalls and/or the like which protect and encapsulate data within the high security environment. In some embodiments, the synthetic data generation system 102 itself may reside in the high security environment.

As described above, example embodiments provide methods and apparatuses that enable user-defined synthetic data generation and improve aspects of conventional processes for generating synthetic data. By implementing a user-friendly interactive graphical user interface that provides a multitude of options for defining and refining a synthetic dataset, example embodiments thus mitigate negative and/or otherwise complex issues that often arise in conventional processes for generate synthetic data. Through utilization of the above-described technical operations in connection with the interactive synthetic data generation UI, new and practical tools are unlocked that allow teams to collaborate on generating synthetic data via an easily digestible UI while also allowing less advanced users to more easily articulate their needs for a synthetic dataset through the various tools of the UI. Further, example embodiments provide an additional level of data protection for source authentic data by within a high security environment, thus avoiding potential exposure of source authentic data to any malicious actors while still enabling productive benefit to be gained from the authentic data. Accordingly, example embodiments thus provide another technical improvement in that they enhance the performance of a computing platform implementing synthetic data generation while still mitigating the risk of exposure of any sensitive authentic data. Furthermore, by enabling real-time generation and delivery of a parameter specification set without intermediate storage, example embodiments enable local generation of synthetic data from sensitive source data without compromising security of the sensitive source data. As these examples all illustrate, example embodiments contemplated herein provide technical solutions that solve real-world technical problems faced during traditional implementations of synthetic data generation.

FIGS. 3-5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for user-defined synthetic data generation, the method comprising:
generating, by interface generation circuitry of a first device, a synthetic data generation user interface (UI) comprising a plurality of synthetic data generation UI elements;
causing presentation, by communications hardware of the first device, of the synthetic data generation UI;
receiving, by the communications hardware of the first device, a user input set comprising a plurality of synthetic dataset requirements generated based on user interactions with the plurality of synthetic data generation UI elements, wherein at least one synthetic dataset requirement of the plurality of synthetic dataset requirements references a pointer to an authentic dataset to be used as a source for generating a synthetic dataset, wherein the authentic dataset is stored on a second device;
preprocessing, by synthetic data generation circuitry of the first device, the user input set to generate a parameter specification set comprising an exportable executable file that, when executed by a processor, is configured to generate the synthetic dataset; and
causing transmission, by the communications hardware of the first device, of the parameter specification set to the second device,
wherein the exportable executable file of the parameter specification set is configured to generate the synthetic dataset at the second device using the authentic dataset stored on the second device.

2. (canceled)

3. The method of claim 1, further comprising:
receiving, by the communications hardware, user credential information prior to generating the synthetic data generation UI,
wherein the synthetic data generation UI is generated based on the user credential information.

4. The method of claim 3, wherein generating the synthetic data generation UI based on the user credential information comprises:
disabling, by the interface generation circuitry, one or more synthetic data generation UI elements based on the user credential information.

5. The method of claim 3, wherein generating the synthetic data generation UI based on the user credential information comprises:
automatically applying, by the interface generation circuitry, default settings to one or more synthetic data generation UI elements based on the user credential information.

6. The method of claim 1, further comprising:
generating, by the synthetic data generation circuitry, the synthetic dataset based on the parameter specification set.

7. The method of claim 6, further comprising:
receiving, by the communications hardware, a request to train a model using the synthetic dataset; and
training, by modeling circuitry and in response to the request, the model using the synthetic dataset.

8. The method of claim 6, further comprising:
causing transmission, by the communications hardware, of the synthetic dataset to a client device.

9. The method of claim 6, wherein the user input set comprises an indication of a source dataset, and
wherein the synthetic dataset is generated based on the source dataset.

10. The method of claim 9, wherein the source dataset comprises a previously generated synthetic dataset.

11. The method of claim 6, wherein the user input set comprises a data sensitivity level indication, and
wherein data points of the synthetic dataset are generated based on the data sensitivity level indication.

12. The method of claim 6, wherein the user input set comprises a selection of one or more predefined synthetic data generation algorithms, and
wherein generating the synthetic dataset uses the selected one or more predefined synthetic data generation algorithms.

13. The method of claim 6, wherein the user input set comprises an indication of a selected degree of bias, and wherein the method further comprises:
generating, by the synthetic data generation circuitry, a plurality of data points of the synthetic dataset based on the selected degree of bias.

14. The method of claim 1, further comprising:
determining, by data analysis circuitry and based on the user input set, a time-to-generate estimation for the synthetic dataset; and
causing presentation, by the communications hardware, of an indication of the time-to-generate estimation.

15. The method of claim 14, further comprising:
updating, by the data analysis circuitry and in real-time, the time-to-generate estimation in response to receiving an updated or additional user input indication; and
causing presentation, by the communications hardware, of the updated time-to-generate estimation.

16. An apparatus for user-defined synthetic data generation, the apparatus comprising:
interface generation circuitry of a first device configured to generate a synthetic data generation user interface (UI) comprising a plurality of synthetic data generation UI elements;
communications hardware of the first device configured to:
cause presentation of the synthetic data generation UI, and
receive a user input set comprising a plurality of synthetic dataset requirements generated based on user interactions with the plurality of synthetic data generation UI elements, wherein at least one synthetic dataset requirement of the plurality of synthetic dataset requirements references a pointer to an authentic dataset to be used as a source for generating a synthetic dataset, wherein the authentic dataset is stored on a second device; and
synthetic data generation circuitry of the first device configured to preprocess the user input set to generate a parameter specification set comprising an exportable executable file that, when executed by a processor, is configured to generate the synthetic dataset,
wherein the communications hardware of the first device is further configured to cause transmission of the parameter specification set to the second device,
wherein the exportable executable file of the parameter specification set is configured to generate the synthetic dataset at the second device using the authentic dataset stored on the second device.

17. (canceled)

18. The apparatus of claim 16, wherein the communications hardware is further configured to:
receive user credential information prior to generating the synthetic data generation UI, wherein the synthetic data generation UI is generated based on the user credential information.

19. The apparatus of claim 16, wherein the synthetic data generation circuitry is further configured to:
generate the synthetic dataset based on the parameter specification set.

20. A computer program product for user-defined synthetic data generation, the computer program product comprising at least one non-transitory computer-readable storage medium storing software instructions that, when executed, cause a first device to:
generate a synthetic data generation user interface (UI) comprising a plurality of synthetic data generation UI elements;
cause presentation of the synthetic data generation UI;
receive a user input set comprising a plurality of synthetic dataset requirements generated based on user interactions with the plurality of synthetic data generation UI elements, wherein at least one synthetic dataset requirement of the plurality of synthetic dataset requirements references a pointer to an authentic dataset to be used as a source for generating a synthetic dataset, wherein the authentic dataset is stored on a second device;
preprocess the user input set to generate a parameter specification set comprising an exportable executable file that, when executed by a processor, is configured to generate the synthetic dataset; and
cause transmission of the parameter specification set to the second device,
wherein the exportable executable file of the parameter specification set is configured to generate the synthetic dataset at the second device using the authentic dataset stored on the second device.
